(19) United States
(12) Patent Application Publication
(10) Pub. No.: US 2014/0367431 A1
(43) Pub. Date: Dec. 18, 2014

(54) BICYCLE CARRIER APPARATUS

(71) Applicant: Keith Sutter, Philadelphia, PA (US)

(72) Inventor: Keith Sutter, Philadelphia, PA (US)

(21) Appl. No.: 13/917,873

(22) Filed: Jun. 14, 2013

(51) Int. Cl. B60R 9/10

(52) U.S. Cl. CPC B60R 9/10
USPC 224/324

(57) ABSTRACT

A bicycle carrier apparatus allows for carrying a bicycle in a secure orientation within the interior cargo area of a vehicle such as, e.g., a sport utility vehicle, station wagon, crossover, hatchback, or mini-van type vehicle. The apparatus is designed to attach unobtrusively or be integrated particularly into a seat headrest, or other region of the vehicle. When the seat is folded down the tireless front fork of a bicycle can engage the apparatus in a secure manner allowing upright transport of the bicycle inside the vehicle. When not in use the apparatus may remain in place on the headrest (or otherwise), not interfering with the normal use of the headrest/seat or other portion of the vehicle to which it is attached, or restricting use of the vehicle's cargo area.

Embodiments of the present invention relate to the field of article transportation; more particularly, to a bicycle carrying apparatus; most particularly, to a bicycle carrier apparatus specifically adapted for use within the interior of a suitable motor vehicle such as, e.g., a sport utility vehicle, a station wagon, a crossover, a hatchback, and a minivan.

A wide variety of bicycle carriers are presently available for use with motor vehicles. Traditional-type bicycle carriers fall into two main categories; rooftop and trunk- or hitch-mounted. However, motor vehicles such as station wagons, minivans, hatchbacks, crossovers, and SUVs, for example, representing nearly half of all U.S. passenger vehicles, have shapes that are less than optimal for using these traditional-type carriers. For use with an SUV, crossover, or mini-van, rooftop carriers are inconvenient, as lifting a bicycle onto these higher roofs can be difficult. For all vehicles, trunk- or tow hitch-attached carriers are inconvenient, as they may need to be reattached each time they are used and, when installed, often prevent full access to the trunk or cargo area. Furthermore, when transporting a bicycle in a station wagon, hatchback, minivan, crossover, SUV, or similar type vehicle not having a conventional rear trunk or boot, laying the bicycle in the cargo area can be inconvenient, physically difficult, and an inefficient use of space.

The inventor has thus recognized the advantages and benefits of a bicycle carrier that could be used inside the cargo area of a suitable motor vehicle, which would provide secure, upright transport of the bicycle, which would minimally or not at all restrict the use of said cargo area when not used to secure a bicycle, as well as other advantages and benefits recognized by bicycle enthusiasts and those skilled in the art. Moreover, securing a bicycle in the cargo area of a suitable motor vehicle for transport in an upright position minimizes chances for chain grease transfer and optimizes use of the cargo area for other gear including front wheels, helmets, shoes, and other cargo. Also, by keeping the bicycle inside the vehicle there is no need to lock it to external racks to guard against theft, while also protecting the bicycle from road hazard damage during transport.

An embodiment of the invention is a bicycle carrier. The bicycle carrier includes an interior-vehicle first mounting member, and a bicycle fork holding component attached to said mounting member that enables a secure, removable attachment of a bicycle fork to the fork holding component. In various non-limiting illustrative and exemplary aspects, the bicycle carrier is further characterized by, or includes one or more of the following:
further comprising a second mounting member removeably connectable in an opposing relationship to the first mounting member;

wherein the mounting members are in the form of elongate bars;

wherein the mounting members have flat inner surfaces;

wherein the mounting members have textured inner surfaces;
further comprising a resilient material attached to an inner surface of at least one of the mounting members
further comprising a second mounting member hingedly attached at an end thereof to a respective end of the first mounting member, and further comprising a closure component disposed or disposable at an opposite end of at least one of the mounting members;

wherein the closure component is a latch;

wherein the closure component is a threaded assembly;
wherein the bicycle fork holding component is a bicycle tension fork.

The term ‘interior-vehicle mounting member’ is limited to a mounting member that is specifically designed to be attached to a designated interior region of a vehicle. Such designated interior region may include, but is not limited to, headrest posts, headrest, seatback, back hatch surface, cargo surface.

According to an illustrative embodiment, in which the bicycle carrier is attached to the headrest posts of the front passenger seat of a vehicle, when a bicycle is to be transported the back seat can be lowered and with the front wheel of the bicycle removed, the front fork of the bicycle can be attached to the fork holding component and the bicycle secured thereto for transport.

According to various non-limiting aspects, the apparatus may be designed into the structure of a vehicle to allow for permanent placement in the vehicle, as could be accomplished by an original equipment vehicle manufacturer or 3^{rd} party aftermarket accessory manufacturers. This apparatus would include an integrated plate between the two headrest posts to which a bike fork mount or other accessories could be attached.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operation of the invention.

The present invention will be more fully understood and appreciated by reading the following detailed description in conjunction with the accompanying drawings, in which:

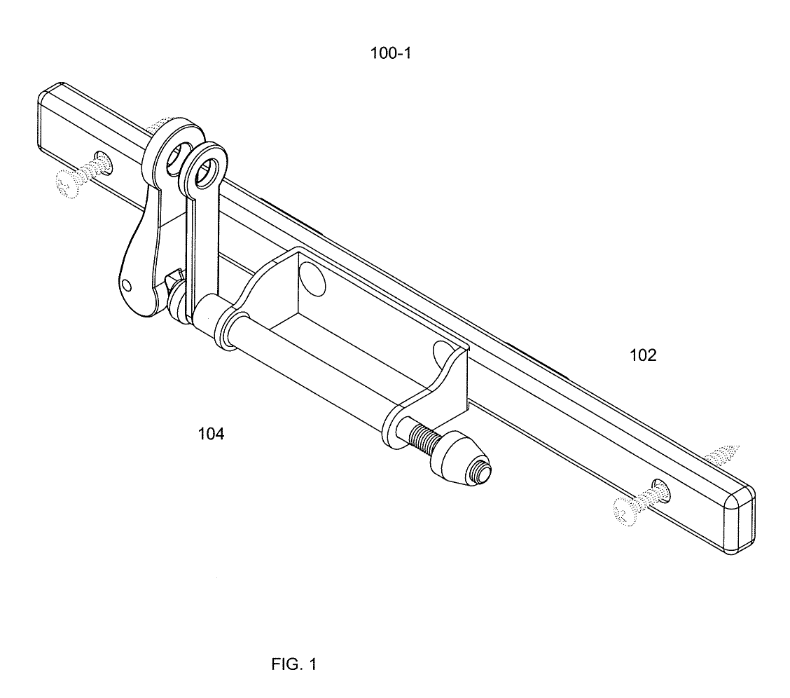

FIG. 1 is a schematic perspective of a bicycle carrier according to an exemplary embodiment of the invention;

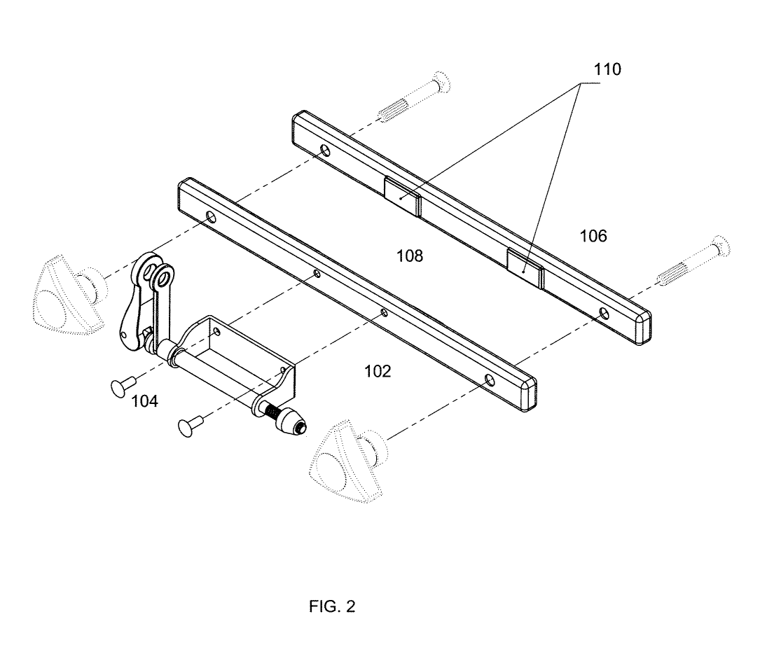

FIG. 2 is a schematic perspective of a bicycle carrier according to an exemplary aspect of the invention;

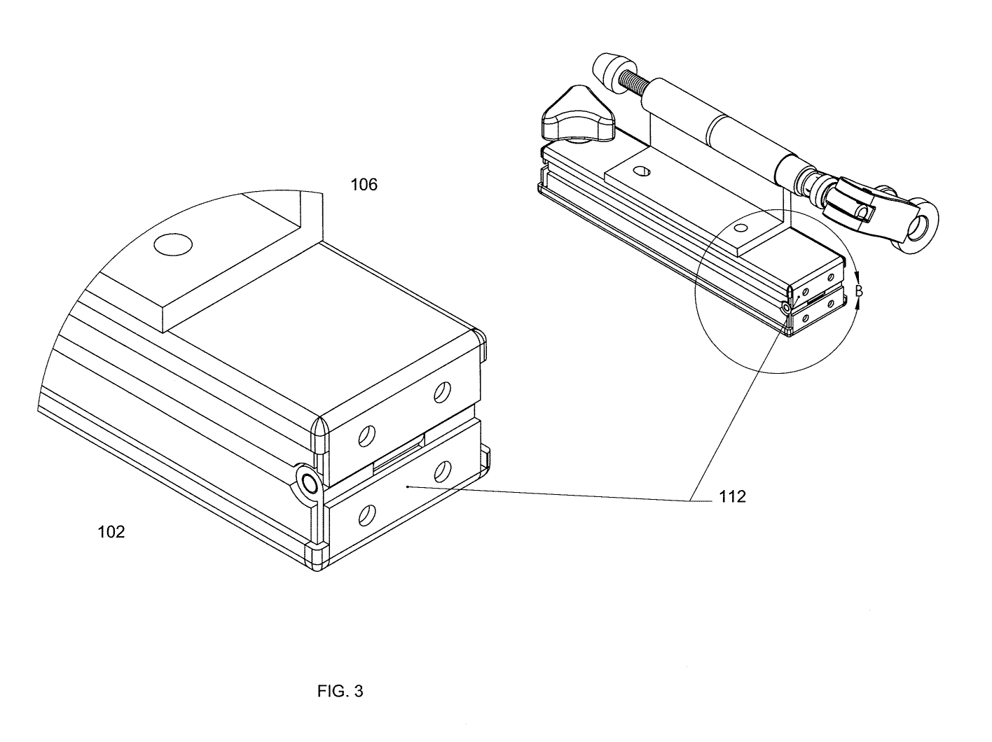

FIG. 3 is a schematic perspective of a bicycle carrier with an exploded view of the bicycle carrier according to an exemplary aspect of the invention;

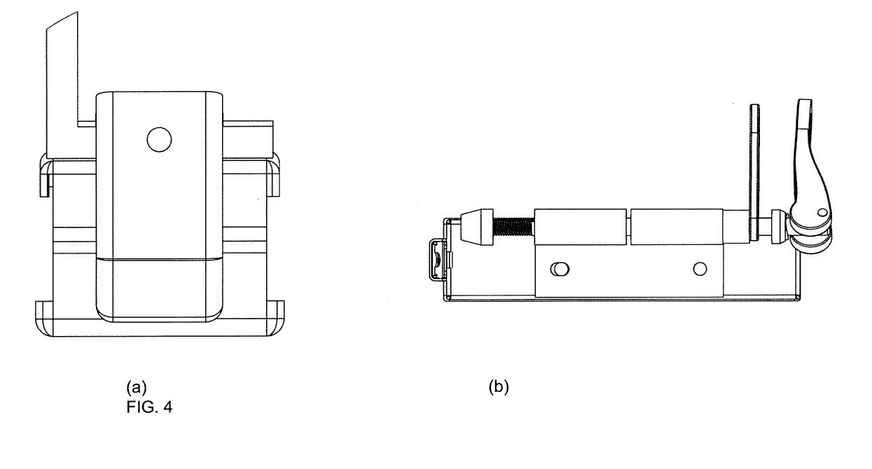

FIG. 4 shows: a) an end view of the bicycle carrier; b) a side elevational view of the bicycle carrier, according to an exemplary aspect of the invention; and

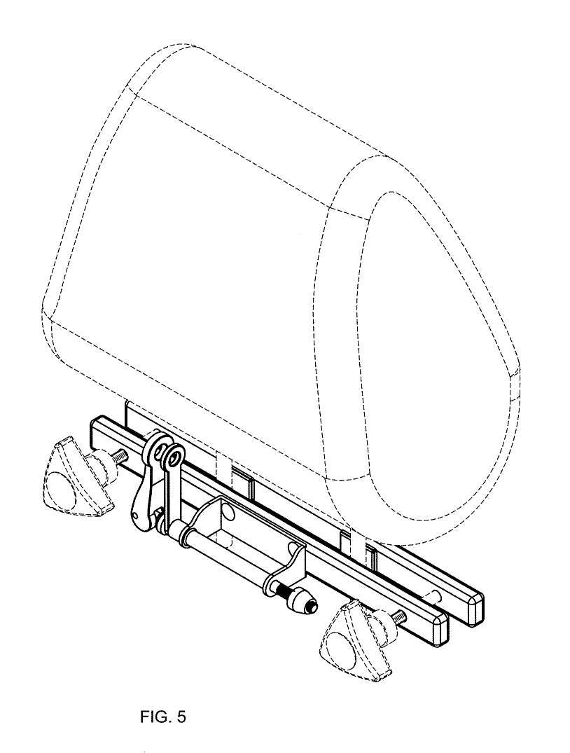

FIG. 5 shows a schematic view of the bicycle carrier attached to a phantom headrest of a vehicle.

### DETAILED DESCRIPTION OF THE EMBODIMENTS OF THE INVENTION

A bicycle carrier 100-1 is illustrated in FIG. 1. Bicycle carrier 100-1 includes an interior-vehicle first mounting member 102 and a bicycle fork holding component 104 that is fixedly attached to mounting member 102. The bicycle fork holding component 104, which is commercially available (e.g., Delta Lockable Bike Hitch available from Delta Cycle of Foxboro, Mass.), enables a secure, removable attachment of a bicycle fork (particularly a front fork) thereto. As shown in FIG. 1, the mounting member 102 is in the form of an elongate bar having a flat inner surface to facilitate mounting the apparatus to a suitable interior surface of a vehicle. The mounting member is shown having two mounting holes to facilitate mounting with screws (shown in phantom) or other attachment means. The fork holding component 104 is shown attached to the mounting member with rivets, but could be securely attached by other means well known in the art.

FIG. 2 shows an exploded view of an alternative aspect of a bicycle carrier 100-2. Bicycle carrier 100-2 is identical to bicycle carrier 100-1 except that it includes a second mounting member 106 that can be removeably connected in an opposing relationship to first mounting member 102. In FIG. 2, the connection means are shown in phantom as a threaded member and an accompanying knob, but other connection means as known in the art could be utilized. Rather than mounting directly to an interior surface of a vehicle (as for bicycle carrier 100-1), the opposing mounting members 102, 106 allow the bicycle carrier 100-2 to be securely clamped about the headrest posts of a seat headrest as illustrated in FIG. 5. One or both of the mounting members may have a textured inner surface region 108 (roughened, saw-tooth, etc.) to add gripping capability. One or both of the mounting members may have a resilient material 110 (e.g., foam, felt, plastic, rubber, etc.) attached to an inner surface of the mounting member(s) to add gripping capability and/or damage resistance.

FIG. 3 illustrates an alternative aspect of a bicycle carrier 100-3 that is similar to bicycle carrier 100-2, except that rather than mounting members 102, 106 being separate and connectable, they are now attached at a common end thereof by a hinge mechanism 112. Bicycle carrier 100-3 can be positioned about the seat headrest posts and secured by closure means at the other end of the mounting members, shown as a threaded member and accompanying knob in FIG. 3.

FIGS. 4a and 4b, respectively, are an end view and a side elevational view of the bicycle carrier 100-3 in which a latch 115 is provided opposite the hinged end of the mounting members.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. No language in the specification should be construed as indicating any non-claimed element as essential to the practice of the invention.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A bicycle carrier, comprising:
an interior-vehicle first mounting member, and
a bicycle fork holding component attached to said mounting member that enables a secure, removable attachment of a bicycle fork to the fork holding component.

2. The bicycle carrier of claim 1, further comprising a second mounting member removeably connectable in an opposing relationship to the first mounting member.

3. The bicycle carrier of claim 2, wherein the mounting members are in the form of elongate bars.

4. The bicycle carrier of claim 2, wherein the mounting members have flat inner surfaces.

5. The bicycle carrier of claim 2, wherein the mounting members have textures inner surfaces.

6. The bicycle carrier of claim 2, further comprising a resilient material attached to an inner surface of at least one of the mounting members.

7. The bicycle carrier of claim 1, further comprising a second mounting member hingedly attached at an end thereof to a respective end of the first mounting member, and further comprising a closure component disposed or disposable at an opposite end of at least one of the mounting members.

8. The bicycle carrier of claim 7, wherein the closure component is a latch.

9. The bicycle carrier of claim 7, wherein the closure component is a threaded assembly.

10. The bicycle carrier of claim 1, wherein the bicycle fork holding component is a bicycle tension fork.
